(19) United States
(12) Patent Application Publication
(10) Pub. No.: US 2008/0263055 A1
(43) Pub. Date: Oct. 23, 2008

(54) Taxonomy-Based Platform for Comprehensive Health Care Management

(76) Inventors: Sanjaya Kumar, Tracy, CA (US); Venkateswara Rao Vanddineni, San Jose, CA (US); Ratnakar Malla, San Jose, CA (US); Ali Rashidee, Pleasanton, CA (US)

Correspondence Address: PILLSBURY WINTHROP SHAW PITTMAN LLP, P.O. BOX 10500, MCLEAN, VA, 22102, US

(21) Appl. No.: 11/962,062

(22) Filed: Dec. 20, 2007

Related U.S. Application Data
(60) Provisional application No. 60/913,208, filed on Apr. 20, 2007.

(51) Int. Cl. G06F 17/30

(52) U.S. Cl. 707/10; 707/E17.009

(57) ABSTRACT

A Web-Native, HIPAA compliant technology provides for real-time management of incident workflow and the delivery of actionable knowledge throughout the healthcare provider organization. More particularly, the technology provides a web-based data capture, analysis and workflow management solution that simplifies the data capture, validation, and submission of health care safety event and occurrence information.

### CROSS-REFERENCE TO RELATED APPLICATIONS

The present application is based on, and claims priority from, U.S. Prov. Appln. No. 60/913,208, filed Apr. 20, 2007, the contents of which are incorporated herein by reference in their entirety.

### FIELD OF THE INVENTION

The present invention relates to health care, and more particularly to a platform for providing comprehensive health care management that can be configured for individual organizations based on a common taxonomy.

### BACKGROUND OF THE INVENTION

Many attempts at computerizing various health care systems have been made, such as computer-based hospital systems and networks for providing patient care, such as patient record-keeping systems, billing systems, etc. Such systems can further include systems for monitoring compliance and coverage of insurance policies and billing. More sophisticated systems such as automatic and computerized medical diagnostics and treatment plans have been proposed. Meanwhile, standard protocols, procedures, and codes have been developed that are amenable to coding and organization of data in computer systems such as CPT, ICD and HL-7. And despite many privacy issues, use of the public Internet in providing health care services has been proposed, including services such as WebMD.

However, despite the computerizations described above, lack of progress remains, for example in the areas of managing standards compliance and patient safety and risk.

For example, health-care organizations (HCOs) are required to provide evidence of compliance with an increasing amount of standards. Conventionally, these are done through a survey process. However, survey-based standards monitoring in HC organizations tax valuable resources and ultimately impact the bottom line. Monitoring activities today are primarily manual processes and are further complicated by Joint Commission unannounced surveys and HIPAA compliance audits. The resource demands continue to increase. For example: (1) Survey readiness activities cost up to 1% of an organization's operating budget; (2) Unannounced survey audits demand continuous readiness as a key component for successful accreditation. (3) Reimbursement is directly impacted by accreditation compliance.

Another area of need is in risk management. Every 30-60 days in any given HCO, it is highly probable that at least one patient will die due to a preventable medical error. It is even more likely that a patient under care will be seriously injured. Only one such error can devastate an organization. The true cost of an adverse event can be irreparable damage, including: (1) the emotional impact on the patient, staff and family, (2) the financial impact on the organization including claims liability cost of care exposure; and (3) the impact on the organization's reputation within the community.

Similarly, quality data reporting initiatives impact a HCO's bottom line. Significant time and money is invested in reporting quality data to organizations such as Joint Commission, CMS and others. Going forward, the stakes are even higher. For example: (1) Pay for performance (P4P) programs are now putting close to $5 million in reimbursements at risk per hospital based on reported quality results; (2) a new IPPS rule ties a 2% market basket payment to public reporting—the reimbursements are lost if the organization fails the audit; and (3) resource intensive implementations of evidenced-based protocols to new registries mean duplicative effort without any revenue to offset the expenditure. It would be desirable to streamline and simplify reporting to organizations such as JCAHO, CMS and others. In sum, effectively addressing patient safety is garnering more and more attention at the state and national levels. The present inventors have recognized a profound need for a comprehensive system that not only meets the demands of healthcare providers today but also expands their capabilities for future aggregation of incident-centric data from a broad base of internal and external data resources. Such a comprehensive system would preferably provide alignment with an ever expanding national standards base including National Patient Safety Goals (NPSG), Joint Commission, National Quality Forum (NQF), professional provider associations, and National Database of Nursing Quality Indicators (NDNQI). Such a system would preferably further provide the ability to automatically generate and, where available, electronically submit data for state and national patient safety initiatives including NYPORTS (New York), PA-PSRS (Pennsylvania), AHCA (Florida) and CHARTS (California) just to name a few.

### SUMMARY OF THE INVENTION

The present invention provides a Web-Native, HIPAA compliant technology for real-time management of incident workflow and the delivery of actionable knowledge throughout the healthcare provider organization. More particularly, the technology provides a web-based data capture, analysis and workflow management solution that simplifies the data capture, validation, and submission of health care safety event and occurrence information.

According to one aspect, an architecture according to the invention provides a scalable platform for managing health care, and particularly compliance with standards, benchmarks, regulations, accreditations, etc.

According to another aspect, the architecture is modular and allows selectable integration of support for a plurality of different health care management functions.

According to another aspect, the architecture is web-based, thereby minimizing the support requirements on the health care organization.

According to another aspect, the architecture incorporates a customizable, comprehensive taxonomy with advanced backend data mapping for standardization, comparative analysis and benchmarking.

According to another aspect, the architecture features a streamlined user interface that further simplifies data entry.

According to another aspect, the architecture provides a “control center” for organizing data throughout the event management lifecycle.

According to another aspect, the architecture allows automatic capture of data from different health care information systems (HIS) in an organization.

By virtue of these and other aspects, the invention meets these challenges head on with a comprehensive system that not only meets the demands of healthcare providers today but also expands their capabilities for future aggregation of incident-centric data from a broad base of internal and external data resources. Another advantage of the back-end data mapping is that it offers opportunities for expansive data input and analysis across multiple dimensions. Still further, the invention makes possible alignment with an ever expanding national standards base.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating a health care management system according to the invention;

FIG. 2 is a block diagram illustrating a health care management platform according to aspects of the invention;

FIG. 3 is a block diagram illustrating a client-server architecture of a health care management platform according to aspects of the invention;

FIG. 4 is a block diagram illustrating web server and browser functionality in a client-server architecture according to example aspects of the invention;

FIG. 5 is a block diagram illustrating data structures and accesses according to aspects of the invention;

FIG. 6 is a sequence diagram illustrating data structures and accesses according to aspects of the invention;

FIG. 7 is a screenshot illustrating an example home page according to aspects of the invention;

FIG. 8 is a block diagram illustrating objects and pages corresponding to a displayed home page according to aspects of the invention;

FIG. 9 is a block diagram illustrating customization features according to aspects of the invention; and

FIG. 10 is a block diagram illustrating reporting and event management functionality according to aspects of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

In general, the invention breaks new ground in the areas of health care safety and risk management by providing a complete workflow for event management including expanded capabilities in the areas of data capturing, data aggregation from secondary sources, and alignment with national/state adverse event reporting requirements. The invention incorporates a customizable, comprehensive taxonomy with advanced backend data mapping for standardization, comparative analysis and benchmarking. In addition, the invention features a streamlined user interface that further simplifies data entry and provides a “control center” for organizing data throughout the event management lifecycle. Further, a new advanced business intelligence reporting module provides real-time knowledge creation in support of quality and safety decisions.

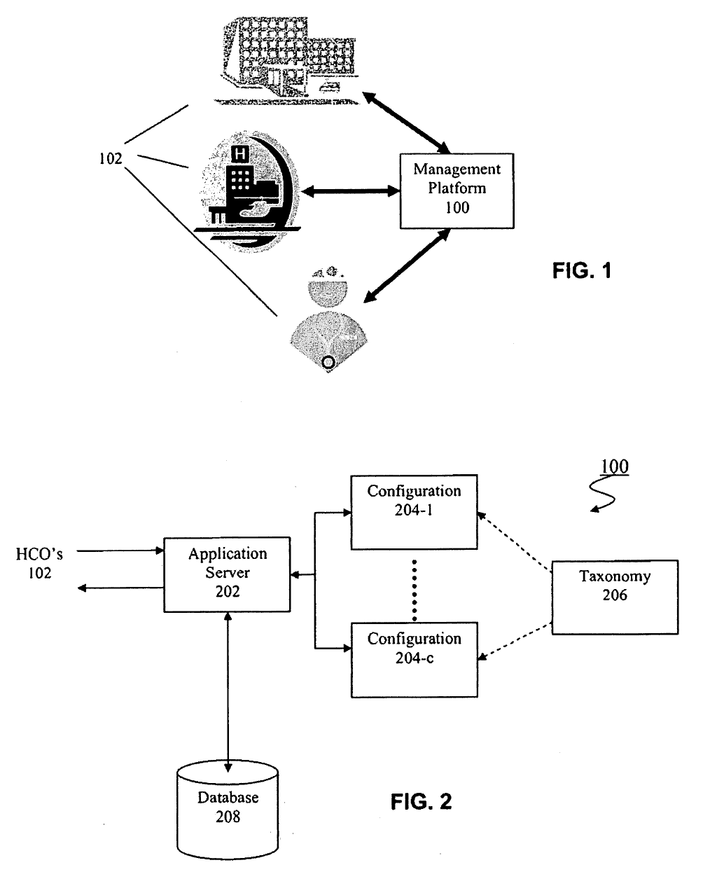

FIG. 1 illustrates an example architecture according to certain aspects of the invention.

As shown in FIG. 1, a health care management platform 100 according to the invention communicates with a plurality of different health care organizations (HCO's) 102. HCOs 102 can be hospitals, nursing homes, clinics, doctors' offices, HMOs, ambulatory care centers, behavioral health centers, dialysis centers, radiology centers, etc. However, while the invention is believed to provide valuable advantages in health care systems, the invention is not limited to health care. Moreover, it should be noted that although only one platform 100 is shown, that this is not necessary, but that there can be more than one, either distributed such as via a network, and/or co-located such as in a load-sharing arrangement. It should be further noted that the invention is not limited to communications with a plurality of HCOs, but there can be just one HCO, and/or there can be communications with other entities. Still further, while the platform 100 is typically located remotely from one or all of the HCOs 102, this is not necessary, and the platform 100 may be located on the same site as one or more of the HCOs 102.

Each HCO 102 may contain one or many systems or devices for communicating with platform 100. HCO 102 may be entirely located in one physical location such as a building, or it can include many buildings located in the same area, or distributed geographically (e.g. a number of buildings, hospitals/clinics in a number of locations). In a preferred, but non-limiting example, the HCOs 102 and platform 100 communicate with each other via the Internet using standard secure protocols such as HTTPS.

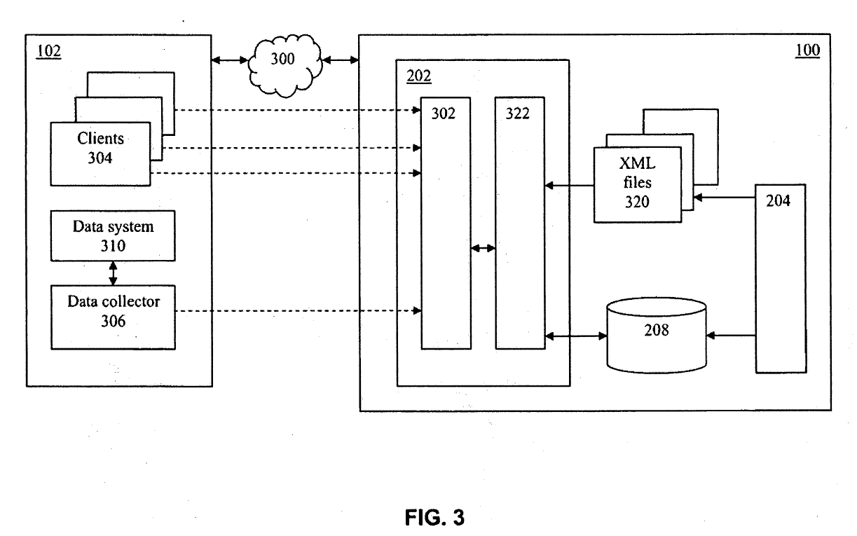

FIG. 2 illustrates aspects of an example implementation of platform 100 according to embodiments of the invention.

As shown in FIG. 2, in some embodiments, platform 100 comprises an application server 202 that communicates with HCOs 102. The application server 202 uses configurations 204 that are respectively associated with the HCOs 102. More particularly, in one example implementation, each HCO 102 has its own configuration 204 that determines how its respective communications and health care management applications are provided.

In this example, configurations 204 are each built on a common taxonomy 206. According to certain aspects of the invention, taxonomy 206 includes a comprehensive set of data elements that can be used to completely describe any health care incident. Preferably, the set of data elements in taxonomy 206 are designed to completely transcend and integrate data elements from disparate systems in a health care organization, while formulating key elements for use in submission to external agencies. For example, the set of data elements in taxonomy 206 permit alignment with the ever expanding national standards base including National Patient Safety Goals (NPSG), Joint Commission, National Quality Forum (NQF), professional provider associations, National Database of Nursing Quality Indicators (NDNQI), Leapfrog, AHRQ and other patient safety indicators. Still further, the data set in taxonomy 206 can provide the ability to automatically generate and, where available, electronically submit data for state and national patient safety initiatives including NYPORTS (New York), PA-PSRS (Pennsylvania), AHCA (Florida) and CHARTS (California), for example. One possible implementation of taxonomy 206 is attached as Appendix A, which forms part of this disclosure and is incorporated herein by reference.

While it is possible that each configuration 204 is different, several HCOs can have the same or very similar configurations 204. In cases where configurations are identical, they need not be stored separately. An example process for generating customized configurations 204 based on taxonomy 206 will be described in more detail below.

As further shown in FIG. 2, application server 202 stores and retrieves data from database 208. Database 208 is implemented by, for example, a database from Oracle Corp. of Redwood Shores, Calif. Database 208 preferably includes a database server such as a Linux server for controlling access to objects stored therein. According to aspects of the invention, data stored in database 208 includes health safety incident data for every HCO 102. An advantage of this implementation is that the HCOs 102 do not need to obtain and maintain their own expensive and/or specialized computer systems and/or databases in order to receive the benefits of the present invention.

Application server 202 can be implemented using a server computer such as those available from HP, IBM, Sun, etc. executing an operating system such as Unix, Linux, Windows, Solaris, etc. and loaded with software having functionality that will be described in more detail below. The various possible implementation details of server 202 will become apparent to those skilled in the art after being taught by the present disclosure.

Generally, in response to the initiation of communications with a particular HCO 102, server 202 retrieves its associated configuration 204. Based on the retrieved configuration 204, server 202 formats the customized communications with the particular HCO 102. The formatted communications can include input forms and/or screens for capturing health care events observed by personnel at HCO 102. The formatted communications can additionally or alternatively include receiving and responding to requests for reports and other information about recorded events, and for generating messages or alarms associated with health care standards with which HCO 102 must comply. The reports can include details of events, summaries of multiple events, graphs and charts of multiple events, and/or reports that are formatted for submission to agencies.

Preferably, server 202 includes authentication mechanisms for ensuring that some or all communications with HCOs 102 are with authorized personnel and/or those with valid privileges to access/modify data. Moreover, it should be apparent that server 202 can communicate with multiple HCOs 102 at the same time and/or multiple clients within HCOs 102 at the same time.

FIG. 3 illustrates certain aspects of the invention in further detail. In this example, HCO 102 includes a plurality of clients 304 and platform 100 communicates with clients 304 in HCO 102 via a network 300 such as the Internet. Clients 304 can be implemented by desktop or laptop computers such as those running Windows from Microsoft Corp. However, many variations are possible, including PDA's, Blackberries, cell phones, smart phones, handheld computers, workstations, thin clients, etc., and other types of operating systems such as Mac OS, Linux, Palm, Unix, etc.

As shown in FIG. 3, HCO 102 can further or alternatively include one or more automatic data collectors 306. Data collector 306 communicates with an existing data system 310 to automatically retrieve data therefrom and transmit the retrieved data to platform 100. For example, in many current HCOs, data system 310 can be comprised of several different IT systems that communicate with each other via a network using a standard protocol called Health Level 7 (HL7), described in detail at www.hl7.org. In general, HL7 provides a messaging format for capturing and describing all aspects of health care, including patient admissions, order entry, accounting, medical records, etc. In such an example, data collector 306 includes a snoop process running on a network device or server that views the headers of all HL7 messages traversing the network. Data collector 306 can also include a rules engine that compares the header contents to a set of predefined validations and checks to determine if any messages are related to an event that should be reported. For example, the snoop process can determine, by looking at the HL7 message header, when an entry is made into patient's medical record that a medication has been given. If this header type is listed as one of the header types to examine, the collector 306 can perform further queries and/or provide a report to platform 100.

As still further shown in FIG. 3, application server 202 in this example implementation includes a web server 302 and web application server 322. Web server 302 includes conventional communication functionality for receiving HTTPS requests from different clients 304 of HCOs 102 over network 300 and forwards them to the Web Application Server 322. In one example implementation, a Weblogic 8.1 server from BEA Systems Inc. of San Jose, Calif. can provide both the web server 302 and web application server 322.

Web application server 322 receives the user requests from the Web server 302 and processes them. It executes appropriate business logic, transacts with the Database Server associated with database 208 and dynamically generates HTML pages for display to the users. The Web application server 322 also provides transaction management, database connection pool, cache optimization, etc. for enhanced performance and scalability of the system. The business logic can be implemented using DAO, DTO, EJB, JSP and XML and can be integrated with the Web application server 322. The implementation details of the business logic will become apparent to those skilled in the art after being taught by the various functionalities described below.

XML files 320 are customized according to configuration 204 for a particular HCO 102. In general, the customization includes mapping data elements from taxonomy 206 into XML files that have pre-defined styles, as will be described in more detail below. For example, as will be described in more detail below, one or more pre-defined XML files 320 are generated using the HCO type, state and submission agencies, etc. Further HCO-specific customizations can also be made and saved as HCO specific XML files 320. Also, these XML's are mapped to the database 208 to store the XML element properties.

Server 302 can determine which files 320 to use in any given communication session with clients 304 and/or interactions with database 208 based on, for example, the network address from which a request is coming from. Those skilled in the art will understand how an HCO 102 can be identified in accordance with network communications, for example the URL of the HCO and/or the IP address from which the HCO is accessing the platform 100.

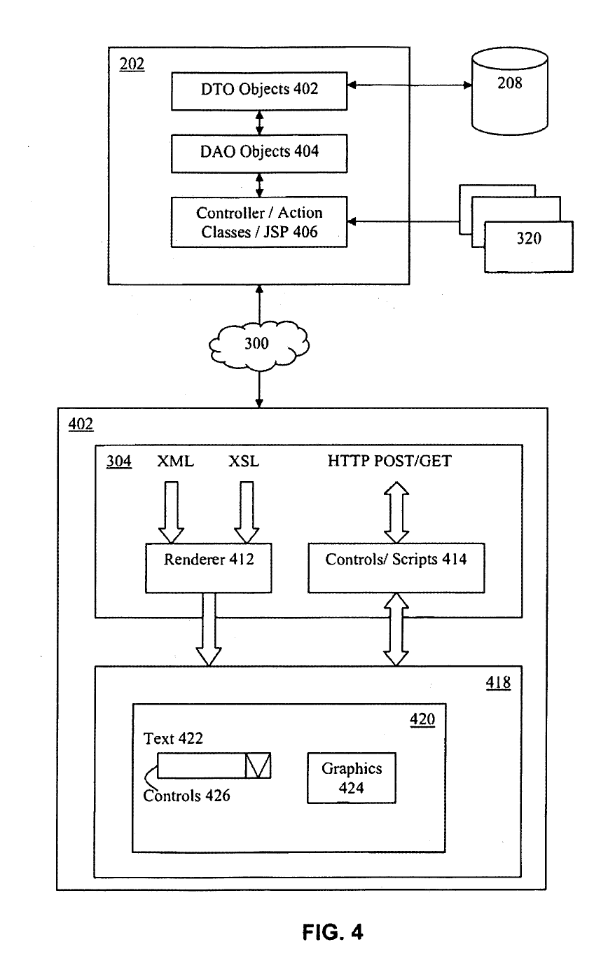

FIG. 4 illustrates certain aspects of an example client 304 according to the invention in more detail. In this example, client 304 includes a browser 402 that communicates with the server 102 via the Internet and World Wide Web (WWW). In one example implementation, the browser is an Internet Explorer from Microsoft Corp., version 5.0 and above. As shown in FIG. 4, the browser preferably includes two main components: renderer 412 and controls and scripts 414. These control interactions with a user via a graphical user interface 420 and a display 418, and are supported by IE versions 5.0 and above.

Controls and scripts 414 can be implemented by ActiveX Controls (XML/XSL, XMLHTTP) and JavaScript scripting language (Validations/Publisher/Subscriber). Renderer 412 can be implemented using concepts of XML/XSL.

More particularly, as shown in FIG. 4, the rendering of the data is done on the browser using renderer 412 which is, for example, a Microsoft ActiveX control (MSXML). The server 202 identifies and sends a definition file (for example, a predetermined XSL file from configurations 320) and data (for example, XML) generated by server 202 using configurations 320, and renderer 412 generates the HTML code for displaying objects on the GUI 420, including text 422, graphics 424 and controls 426. Those skilled in the art will understand how renderer 412 having these capabilities can be implemented with MSXML for browsers such as Internet Explorer after being taught by the present disclosure.

The controls 426 rendered by browser 402 are typically associated with controls 414. For example, the Msxml2.DOMdocument.4.0 ActiveX controls provide flexibility for rendering the GUI using XML and XSL. These controls can also include XMLHttp type and/or Ajax controls, which can make server calls asynchronously, which means there will be no refreshing of the browser page when a call is made to the browser. These types of controls can be used, for example, wherever there is reference information changing based on certain conditions or when getting specific reference information such as medication lists, patient information, etc. An advantage of this approach is that the HTML will look like an local application on the desktop.

Controls 426 can also be associated with controls 414 such as JavaScript. In one example, this scripting language can be used for client side validations such as Mandatory fields, Alert statements, messages, calendar controls and to access the ActiveX components on the browser.

As shown in FIG. 4, the client requests and responses are handled through the Controller or Action Classes/JSP pages (i.e. business objects) 406. In a preferred implementation, Servlets are avoided and instead the Controller classes and Action Classes with a GUI framework are used. Controller or Action classes 406 in turn invoke a DAO object 404 to perform the functions and respond back using JSP pages. The DAO objects 404 in turn make the database 208 connections and use the DTO objects 402 for performing data retrieval and storage operations.

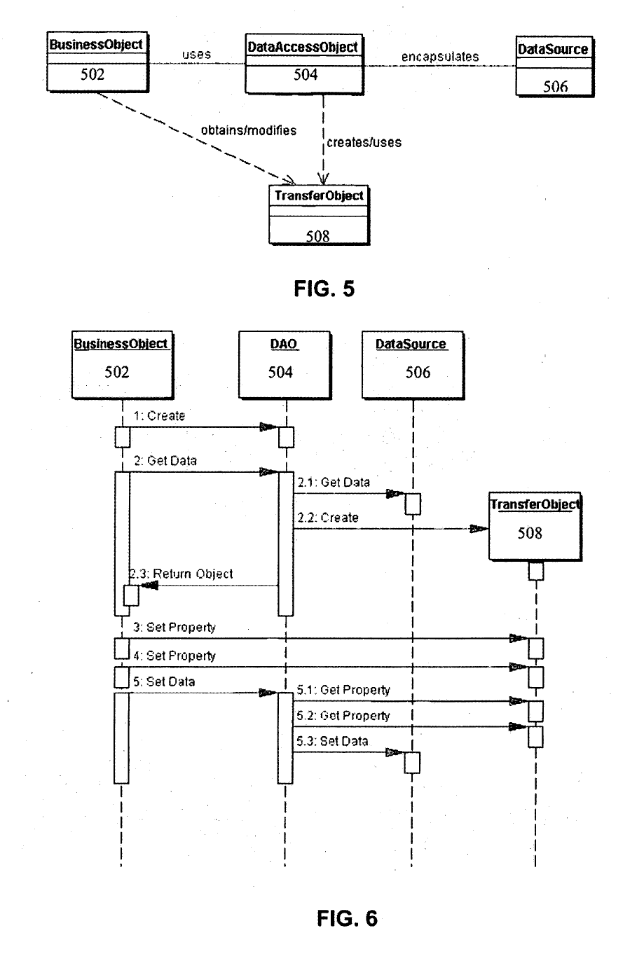

In one example implementation shown in FIG. 5, the data access structure comprises: Business Objects 502, Data Access Objects 504, Data Sources 506 and Transfer Objects 508. Business Objects 502 are the first objects invoked on the web server 202 by client submission/action which contains the business logic for clients action. These objects are called from a Controller servlet in one example implementation. Business Objects 502 may be implemented as session beans or Java Objects in addition to Servlets, Action Classes and JSP. Data Access Objects 504 abstract the underlying data access implementation for the Business Object 502 to enable transparent access to the data source 506. Business Objects 502 provide the data access layer and delegate the data load and data store operations to the Data Access Objects 504. So the Data Access Objects (DAO) perform the tasks of saving of data or retrieving of data, while the connection object to the database is provided to the DAO. Data Sources 506 are objects in the database 208 such as an Oracle database. Transfer Objects 508 are the Data Transfer Objects (DTOs), which are used as data carriers. DAOs return the data to the Business Objects 502 in the form of DTOs. Also, the DAOs receive the data from the Business Objects as DTOs which are then updated in the database 208.

A sequence diagram illustrating one example of how data in the database can be accessed and stored using the data access structure described above is shown in FIG. 6.

More particularly, the sequence diagram describes how the business object 502 first invokes the data access object 504 through the create method, and next, from the GetData method, how the data access object 504 in turn creates the data transfer object 508 using the data source 506 (which in this case is a JDBC connection to the database). The data transfer object 508 is returned to the business object through the same GetData method. Now the business object can set properties and values and finally call the SetData method to commit the values into the source 506 (database). Those skilled in the art will appreciate that there are many possible alternative implementations s to this example.

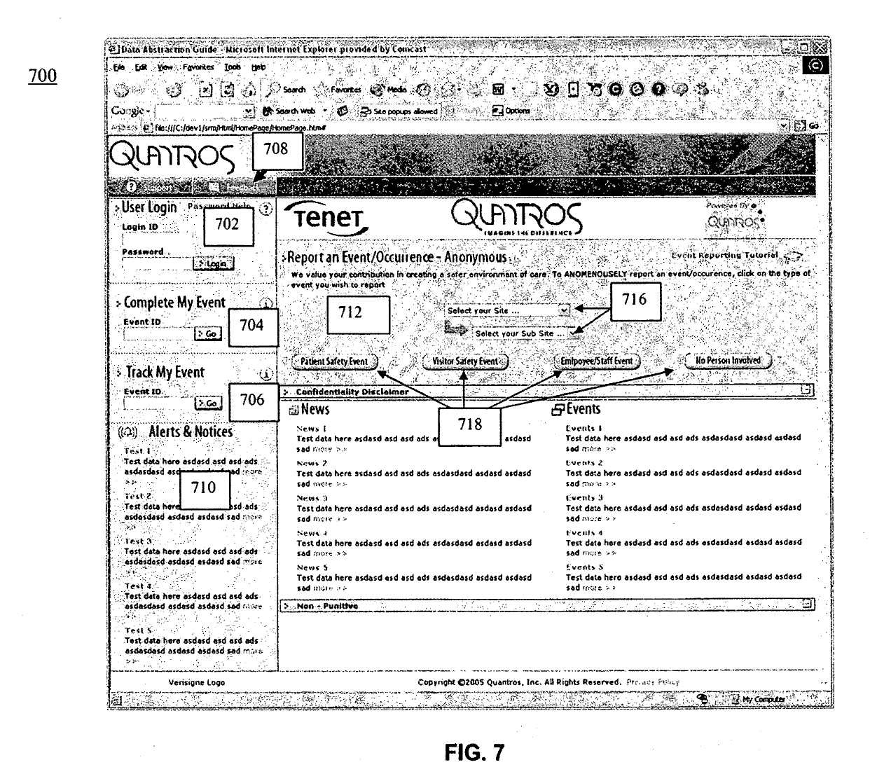

FIG. 7 is an example of a screen (e.g. home page) 700 that can be rendered by a browser 402 in accordance with certain aspects of the invention. As shown in FIG. 7, screen 700 in this example includes a Login box 702, an event tracker box 704, an event completion box 706, a Help/Feedback control 708, a News & Alerts box 710, and an event reporting screen 712.

According to aspects of the invention, event reporting screen 712 allows for capturing health care events observed by personnel at HCO 102. By implementing screen 712 on a browser loaded on a Windows or Mac desktop or notebook computer, no special equipment or software is needed, nor is any particular training, as the GUI is readily familiar to most personnel. More particularly, in the example of FIG. 7, an HCO 102 is configured to allow any user, including those who wish to remain anonymous, to report an event or occurrence. In this example, via reporting controls 714 the user is allowed to report a patient safety event, a visitor safety event, an employee/staff event, or an event in which no person was involved. As further shown in this example, HCO 102 includes sites and sub-sites (e.g. different facilities and/or buildings within the HCO) from which the user is allowed to select via drop-down lists 716. An example description of how a web-based system built on the principles of the invention can manage risk and safety events in a health care organization is provided in the attached Appendix.

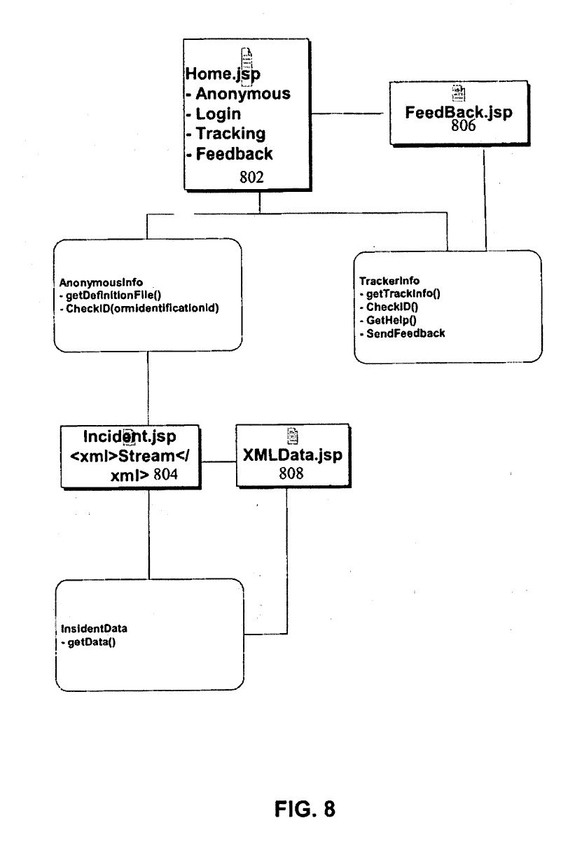

In one example implementation, JSP pages are used to capture additional information, and business objects 502 on the server handle the business logic. The business objects in turn invoke the appropriate access objects 504 as explained above. This aspect is illustrated in more detail in FIG. 8. As shown in FIG. 8, JSP pages generated in accordance with the HCO's configuration capture additional information, and the rounded rectangles correspond to the action/business objects 502 on the server 202, which handle the business logic.

More specifically, the Home JSP 802 corresponds to the overall screen 700, and includes code for displaying the content of screen 700 and for capturing certain additional information, such as the selections from drop-down lists 716, and information from boxes 702, 704 and 706.

For example, Home JSP 802 displays and captures information from Login box 702, which allows registered users to access health care reporting services of the HCO. In one example implementation, this process requires the form tag in the JSP page to have the action attribute to a controller object, with the ServName as “Login”. This in turn will call the QLogin action/business object.

Event tracker box 704 on the screen 700 is used for tracking any event for a given SRM Identification ID, which is a randomly generated ID given for a reported event.

Event completion box 706 in screen 700 preferably allows users to partially report an event and save it as incomplete. The system will provide a unique SRM Identification ID and the user can later access and complete the report by providing this ID in the box 706. The concept and the functionality is preferably the same, but the data stored and retrieved from will be different. The retrieved data will be an XML file from the database 208. Specifically, as shown in FIG. 8, in one example implementation, this process calls the AnonymousInfo action/business object, and this object checks for the input id (which is the incident id). The incident id is passed as a query string for the IncidentData object embedded in the form of XML tag (<xml src=“/srm/Controller?ServName=IncidentData&id=??></xml>).

Any selection of reporting controls 714 will trigger a reporting screen (Incident.jsp) 804 which will in turn use the IncidentData action/business object to retrieve the HCO specific XML definition and the XSL and display the HCO customized taxonomy data. Once the data is filled and saved, the data is saved as XML and as individual elements in the database 208.

As further shown in FIG. 8, if a user selects help/feedback control 708, it will popup a window (FeedBack.jsp) 806, where the user has the choice of entering the comments/feedback. The submission by the user triggers the TrackerInfo action/business Object and calls the sendFeedBack( ) function. This function can include sending email to a support person or department.

News and Alerts box 710 connects to a properties file on the web server which contains system-wide and/or HCO specific News and Events. The login page will read from the properties files and display the contents in the appropriate area or pane on the JSP.

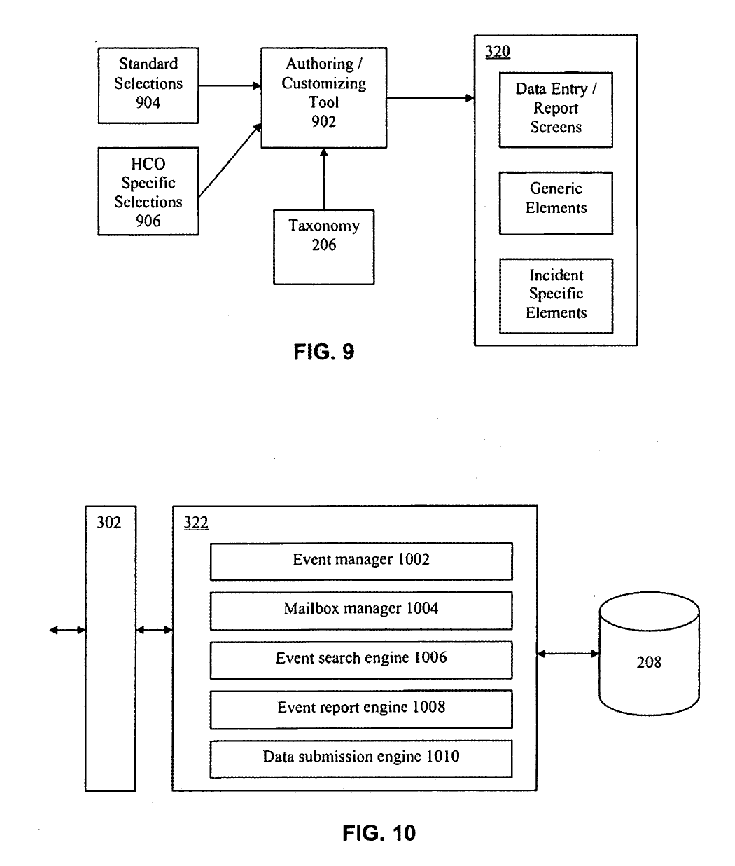

According to additional aspects of the invention, most of the screen 700, as well as the underlying data and corresponding labels, is customizable with the particular requirements of a given HCO 102. More particularly, as shown in the FIG. 9, and as mentioned above, each HCO 102 has the option of Authoring/Customizing its own data entry screens and reporting scheme in accordance with pre-defined Generic elements and OT (Incident) Specific Elements in taxonomy 206. The output of a customization will be XML file(s) 320 specific to that HCO 102 or Group within a HCO (Example CHP hospitals). These XML files will be saved in the hospital specific directory (described in more detail below) and during the data entry or reporting the application will use the format captured in the XML files.

As set forth above, taxonomy 206 includes a comprehensive set of data elements that can be used to completely describe any health care incident. In general these data elements include lists of possible types of events, lists of possible types of event reporters together with their possible roles and privileges in event reporting and management, lists of possible HCO employees and staff, lists of possible data elements describing an event (e.g. date, time, person affected, medication used, HCO department where event occurred, etc.), and lists of possible descriptions of event status and followup. An example of a taxonomy 206 that can be used with the invention is attached as Appendix A.

In the example shown in FIG. 9, the invention includes an authoring/customization tool 902 that generates customized XML files 320 based on taxonomy 206, standard selections 904, and HCO specific selections 906. For example, standard selections 904 can allow mapping data elements from taxonomy 206 into XML files that have pre-defined styles based on HCO type (e.g. hospital, nursing home, clinic, doctors' office, etc.) state, and submission agencies (e.g. NYPORTS (New York), PA-PSRS (Pennsylvania), AHCA (Florida) and CHARTS (California), etc.). In other words, based on a selection of a list of these and other pre-determined options, a pre-determined set of XML files 320 can be generated by tool 902.

Further HCO-specific customizations can also be made using tool 902 based on HCO specific selections 906 and saved as HCO specific XML files 320. In one example implementation, HCOs will have the option to perform the following customizations of the data entry and/or reporting scheme: Change pre-defined labels; Specify whether each data element is Optional/Mandatory; Specify/select different options for each elements (Example Dropdown values, but should map to elements in taxonomy 206); Specify who can view the element in preview (Example Anonymous/Registered/Legal); Specify who can Add/Edit the element value (Example Anonymous/Registered).

Tool 902 can be implemented by a software program executing on a computing device (e.g. laptop or desktop computer), for example. The tool 902 can further include user interface functionality for providing drop-down lists and other types of controls for making selections of certain pre-defined customizations as should be apparent from above. It can also further include functionality for making predetermined sets of changes based on the user selections. For example, the tool can allow an administrator to change the label for an event type from “Wrong Drug” to “Wrong Medication,” and the tool can cause the XML file to be changed accordingly, which will be reflected on the event reporting page (e.g. box 718).

As further shown in FIG. 9, the generated XML files 320 according to one preferred implementation provide customized definitions for data entry and reporting screens, generic data elements, and incident specific elements.

Data entry and reporting screens can be customized with HCO specific images and Logos, and other functional and descriptive configurations. For example, the HCO can choose to have the “Reporting an Event” control not to be displayed as shown in FIG. 7, and instead choose to require a person to login to the application to report an Event. Following are some further example options for customizing, which can be implemented in the XML definition for the home page or screen 700: Track My Event; Icons (Maximum of three and pre-defined width and height); Report an Event; Confidentiality Disclaimer Text; Non-Punitive Text; Add/Remove new Alerts & Notifications; Add/Remove new News; Add/Remove new Events.

Generic Data Elements are common across all the OT's (Incidents), such as date, time, first name, last name, patient number, patient type, severity, etc.

HCO and incident specific elements can include XML definitions for Patients, Visitors, Employee, No Person involved, and OT specifics, etc.

Following customization and generation of XML files 320, each HCO 102 preferably has its own directory accessible to the application server 202, which will contain its respective customized XML file(s) 320. For example, if an organization's name has a short abbreviation of DHS and the organization has three HCO's/Facilities, then the directory structure would be as follows:
Base Directory: A predefined location for the server 202 on a fixed or networked drive, such as a C: drive.
Organization Directory: <Base Directory>\DHS
First HCO: <Organization Directory>\DSS1
Second HCO: <Organization Directory>\DSS2
Third HCO: <Organization Directory>\DSS3
Each of these HCO directories should contain the following directories:
   Home.xml (Home page 700 definition file)
   images (HCO specific Image directory)
   srmgen directory (Should contain SRM_<XXX>.xml file, XXX is Patient/Visitor/Staff/etc)
   srmot directory (Should contain SRMOT_<XXX>.xml file, XXX is each OT file)
   rrm directory (Any RRM related information)
   survey directory (Survey related information)

According to aspects of the invention, certain or all users can access the system using clients 304 to manage events, receive reports of events and/or incidents that have been recorded by themselves and/or other users, and perform other followup with events.

For example, as shown in FIG. 10, an administrator and/or other personnel can interact with an event manager 1002 to view, classify and assign and complete follow-up tasks in connection with events that have been recorded in the system and stored in database 208. In this regard, web application server 322 can further include a mailbox manager 1004 that can provide an online mail manager for handling communications regarding events. For example, mails can include information about events, and mailbox manager 1004 manages communications between users (e.g. sending and receiving messages) regarding follow-up tasks. An administrator can establish online mail accounts for certain employees, and further configure how certain emails are routed. Those skilled in the art will understand how to implement this functionality using standard web-based mail technologies.

As further shown in FIG. 10, web application server 322 can further include an event search engine 1006 that can search for events by such criteria as event ID, classification, reported date, affected person, event type and so on, and provide information on matching events. For example, engine 1006 can include conventional search mechanisms for extracting keywords from a query and using those keywords to search database 208.

In embodiments, web application server 322 further includes event report engine 1008 that provides displays of event summaries, followup summaries, charts and other reports regarding events that have been recorded. Engine 1008 can also provide the ability to enter criteria or parameters similar to those in search engine 1006 and to create pre-formatted reports for viewing and/or printing. Search engine 1006 can also include capabilities to do ad hoc queries to retrieve data from database 208 and present results in an HTML/XSL/PDF format using conventional mechanisms familiar to those skilled in the art and adapted in accordance with the principles of the invention.

According to additional aspects of the invention, web application server 322 further includes data submission engine 1010 that can sort or classify events according to certain predetermined conditions and prepare output data in a format that is required by external parties such as accreditation agencies. In embodiments, engine 1010 can submit the data either online, via a printed report, or by creating an XML file to upload to an agency in accordance with the agency's reporting standards and using network data submission techniques that are known in the art.

Those skilled in the art will be able to understand how to implement the user interface and database 208 interaction functionality of managers 1002 and 1004 and engines 1006, 1008, 1010 using objects, classes and JSPs such as those described above in connection with FIGS. 4 to 6.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A system comprising:
one or more servers adapted to communicate with hosts over a computer network;
one or more databases adapted to store event information and coupled to the server;
a first configuration that the server uses to manage communications with one or more hosts of a first organization, and to store and retrieve event information for the first organization in the database; and
a second different configuration that the server uses to manage communications with one or more hosts of a second different organization, and to store and retrieve event information for the second organization in the database.

2. A system according to claim 1, wherein the server includes a web server and the computer network includes the public Internet, and wherein the server is remotely located from the first and second organizations.

3. A system according to claim 2, wherein the web server formats content for web pages that are displayed by the hosts in accordance with the first and second configurations, such that the web pages are different for the first and second organizations.

4. A system according to claim 3, wherein web pages include forms for allowing the event information to be inputted using the hosts.

5. A system according to claim 3, wherein the web pages include reports for allowing the event information to be displayed using the hosts.

6. A system according to claim 3, wherein the web pages include search controls for allowing the event information to be searched in accordance with inputted criteria using the hosts.

7. A system according to claim 1, wherein the first and second configurations are derived from one and the same taxonomy.

8. A system according to claim 7, wherein the taxonomy provides a comprehensive set of data elements for describing a health care event in compliance with a plurality of standards organizations.

9. A system according to claim 8, wherein the first and second organizations are health care organizations, and the event information comprises information about the health care event.

10. A system according to claim 9, further comprising a data submission engine for creating a report about the health care event in accordance with certain of the standards organizations.

11. A system according to claim 1, further comprising a data collector that automatically detects the event information from messages sent by existing systems within one of the first and second organizations.

12. A method comprising:
adapting one or more servers to communicate with hosts over a computer network;
adapting one or more databases to store event information and to be coupled to the server,
using, by the server, a first configuration to manage communications with one or more hosts of a first organization, and to store and retrieve event information for the first organization in the database; and
using, by the server, a second different configuration to manage communications with one or more hosts of a second different organization, and to store and retrieve event information for the second organization in the database.

13. A method according to claim 12, wherein the server includes a web server and the computer network includes the public Internet, and wherein the server is remotely located from the first and second organizations.

14. A method according to claim 13, further comprising:
formatting, by the web server, content for web pages that are displayed by the hosts in accordance with the first and second configurations, such that the web pages are different for the first and second organizations.

15. A method according to claim 14, wherein web pages include forms for allowing the event information to be inputted using the hosts.

16. A method according to claim 14, wherein the web pages include reports for allowing the event information to be displayed using the hosts.

17. A method according to claim 14, wherein the web pages include search controls for allowing the event information to be searched in accordance with inputted criteria using the hosts.

18. A method according to claim 12, further comprising:
deriving the first and second configurations are derived from one and the same taxonomy.

19. A method according to claim 18, wherein the taxonomy provides a comprehensive set of data elements for describing a health care event in compliance with a plurality of standards organizations.

20. A method according to claim 19, wherein the first and second organizations are health care organizations, and the event information comprises information about the health care event.

21. A method according to claim 20, further comprising:
creating a report about the health care event in accordance with certain of the standards organizations.

22. A method according to claim 12, further comprising:
automatically detecting the event information from messages sent by existing systems within one of the first and second organizations.
